(19) United States
(12) Patent Application Publication
(10) Pub. No.: US 2011/0025821 A1
(43) Pub. Date: Feb. 3, 2011

(54) MULTICAST STEREOSCOPIC VIDEO SYNCHRONIZATION

(75) Inventors: William Allen Curtis, Austin, TX (US); Pratik Mehta, Austin, TX (US); Thomas Alexander Shows, Leander, TX (US)

Correspondence Address: HAYNES AND BOONE, LLP;IP Section, 2323 Victory Avenue, Suite 700, Dallas, TX, 75219, US

(73) Assignee: Dell Products L.P., Round Rock, TX (US)

(21) Appl. No.: 12/512,473

(22) Filed: Jul. 30, 2009

(51) Int. Cl. H04N 13/00; H04N 13/04

(52) U.S. Cl. 348/43; 348/54; 348/E13.001

(57) ABSTRACT

Multicast stereoscopic video synchronization includes generating synchronizing information correlated to an image sequence that includes a series of left eye images and a series of right eye images, and transmitting a radio frequency communication signal that includes the synchronizing information.

### BACKGROUND

The present disclosure relates generally to information handling systems (IHSs), and more particularly to multicast stereoscopic video synchronization for an IHS.

As the value and use of information continues to increase, individuals and businesses seek additional ways to process and store information. One option is an information handling system (IHS). An IHS generally processes, compiles, stores, and/or communicates information or data for business, personal, or other purposes. Because technology and information handling needs and requirements may vary between different applications, IHSs may also vary regarding what information is handled, how the information is handled, how much information is processed, stored, or communicated, and how quickly and efficiently the information may be processed, stored, or communicated. The variations in IHSs allow for IHSs to be general or configured for a specific user or specific use such as financial transaction processing, airline reservations, enterprise data storage, or global communications. In addition, IHSs may include a variety of hardware and software components that may be configured to process, store, and communicate information and may include one or more computer systems, data storage systems, and networking systems.

The use of perceived three dimensional (3D) television, video, gaming and the like on two dimensional (2D) display devices is increasing in popularity and use. The perception of viewing video images as 3D images on the 2D display devices is performed by providing two different image perspectives of the video on the display device. One perspective is from a viewer's right eye and the other perspective is from the viewer's left eye. Stereoscopic glasses allow the viewer's right eye to only see the right eye images and also allow the viewer's left eye to only see the left eye images. The 3D systems allow viewers to perceive that they are seeing 3D objects in a 2D display surface by using a principal of binocular disparity. Binocular disparity is the difference between what the viewer's left eye sees and what the viewer's right eye sees, the viewer's distance between their eyes and a focal point depth. When the images from the left eye and images from the right eye are transferred by the viewer's respective eye to the viewer's optic nerve, the images are merged and the optic nerve resolves the disparity to determine which viewed objects are closer to the viewer. This principal is combined with monocular depth cues, such as objects moving faster/slower, objects increasing/decreasing in size, and objects obstructing other objects so that the viewer's brain is presented with a greater approximation of what is presented for viewer's vision system in the real world.

In light of these principles, 3D video viewing on a 2D display device has been accomplished using a variety of different types of viewer glasses (e.g., anaglyph (red/cyan) glasses, passive polarized glasses and active shutter glasses) to allow the viewer's right eye to only see the right eye images and to allow the viewer's left eye only sees the left eye images. Active shutter glasses traditionally use an infrared (IR) communication signal to synchronize a shutter mechanism in front of each eye to open and close each shutter to alternate viewing for the viewer's left and right eyes. Using IR communication for these shutter glasses presents several problems, such a lack of bidirectional communication for the glasses, a requirement of a line of sight for communication, interference with other IR devices (e.g., remote controls), a lack of multiple simultaneous synchronized links and difficulty in synchronizing multiple display sources to the same viewer.

Accordingly, it would be desirable to provide improved multicast stereoscopic video synchronization.

### SUMMARY

According to one embodiment, multicast stereoscopic video synchronization includes generating synchronizing information correlated to an image sequence that includes a series of left eye images and a series of right eye images, and transmitting a radio frequency communication signal that includes the synchronizing information.

### BRIEF DESCRIPTION OF THE DRAWINGS

FIG. 1 is a block diagram illustrating an information handling system (IHS) that embodies aspects of the present disclosure.

FIG. 2 is a block diagram showing shutter glasses and the IHS of FIG. 1.

FIG. 3 is a communication signal timing diagram for the communication signals of FIG. 2.

FIG. 4 is a block diagram showing an alternative image sequence for the system of FIG. 2.

FIG. 5 is a block diagram showing the shutter glasses and IHS of FIG. 2 coupled to an additional display device.

FIGS. 6-9 show block diagrams for alternative embodiments of communication systems for viewing devices and the IHS of FIG. 1.

### DETAILED DESCRIPTION

For purposes of this disclosure, an information handling system (IHS) includes any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an IHS may be a personal computer, a network storage device, or any other suitable device and may vary in size, shape, performance, functionality, and price. The IHS may include random access memory (RAM), one or more processing resources such as a central processing unit (CPU) or hardware or software control logic, read only memory (ROM), and/or other types of nonvolatile memory. Additional components of the IHS may include one or more disk drives, one or more network ports for communicating with external devices as well as various input and output (I/O) devices, such as a keyboard, a mouse, and a video display. The IHS may also include one or more buses operable to transmit communications between the various hardware components.

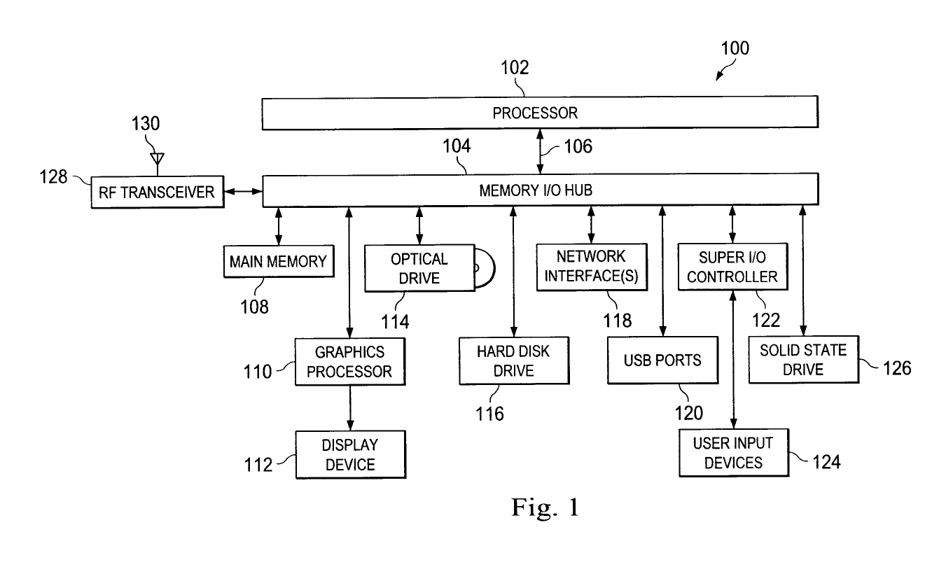

FIG. 1 is a block diagram of one IHS 100. The IHS 100 includes a processor 102 such as an Intel Pentium™ series processor or any other processor available. A memory I/O hub chipset 104 (comprising one or more integrated circuits) connects to processor 102 over a front-side bus 106. Memory I/O hub 104 provides the processor 102 with access to a variety of resources. Main memory 108 connects to memory I/O hub 104 over a memory or data bus. A graphics processor 110 also connects to memory I/O hub 104, allowing the graphics processor to communicate, e.g., with processor 102 and main memory 108. Graphics processor 110, in turn, provides display signals to a display device 112. The display device 112 may be a cathode ray tube (CRT) display device, a Digital Light Processing (DLP™) display device, a liquid crystal display (LCD) device, a projection display device or any other type of display device. The IHS 100 supports displaying images such as video, gaming displays, etc. on any number of display devices 112, whether incorporated into the IHS 100 or coupled to the IHS 100. The display device 112 may include a processor, a graphics processor and/or memory to perform data processing for displaying images.

Other resources can also be coupled to the system through the memory I/O hub 104 using a data bus, including an optical drive 114 or other removable-media drive, one or more hard disk drives 116, one or more network interfaces 118, one or more Universal Serial Bus (USB) ports 120, and a super I/O controller 122 to provide access to user input devices 124, etc. The IHS 100 may also include a solid state drive (SSDs) 126 in place of, or in addition to main memory 108, the optical drive 114, and/or a hard disk drive 116. It is understood that any or all of the drive devices 114, 116, and 126 may be located locally with the IHS 100, located remotely from the IHS 100, and/or they may be virtual with respect to the IHS 100.

A radio frequency (RF) transceiver 128 is shown coupled to the memory I/O hub 104 of the IHS 100. The transceiver 128 includes electrical circuitry to transmit and receive radio frequency communication signals for the IHS 100. The transceiver 128 transmits and receives the communication signals at a carrier frequency of approximately 2.400 GHz. Alternatively, the transceiver could transmit and receive the communication signals at any other desired frequency. The transceiver 128 is part of the IHS 100. Alternatively, the transceiver may be a stand-alone device coupled to the IHS 100 and the display device 112.

An antenna 130 is coupled to the transceiver 128. The antenna 130 radiates the communication signals from the transceiver 128. Additionally, the antenna 130 receives radiated communication signals from the air and communicates the received communication signals to the transceiver 128.

Not all IHSs include each of the components shown in FIG. 1, and other components not shown may exist. Furthermore, some components shown as separate may exist in an integrated package or be integrated in a common integrated circuit with other components, for example, the processor 102 and the memory I/O hub 104 can be combined together. As can be appreciated, many systems are expandable, and include or can include a variety of components, including redundant or parallel resources.

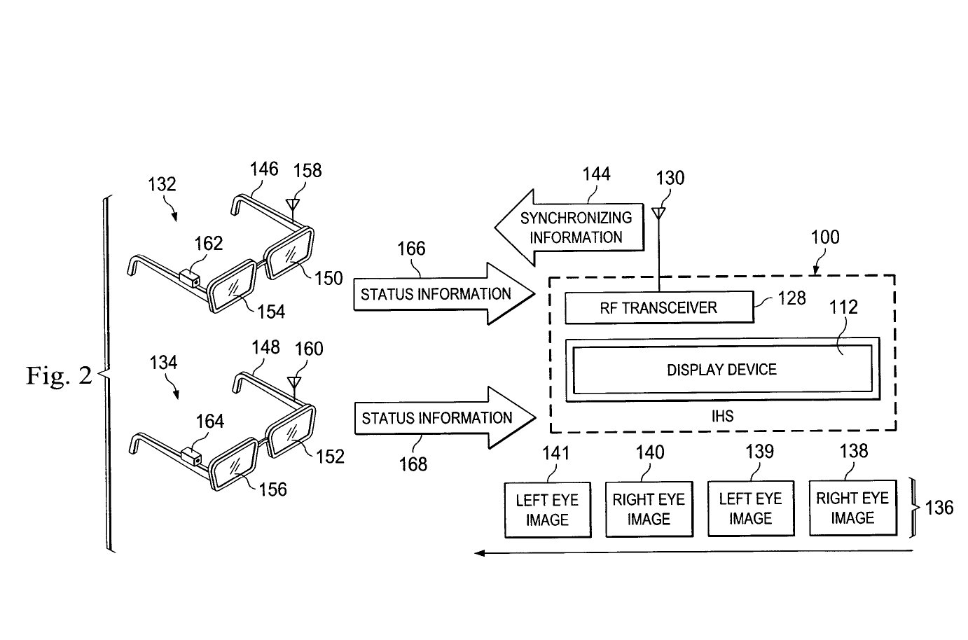

FIG. 2 is a block diagram showing shutter glasses 132 and 134 and the IHS 100. A video image sequence 136 is displayed on the display device 112 of the IHS 100. The image sequence 136 includes a series of right eye images 138 and 140 in alternating sequence with a series of left eye images 139 and 141. The images 138-141 are still images of a television program, video gaming images, or other images that, when viewed in series, appear to be moving. The right eye images 138 and 140 correspond to a perspective of a viewer's right eye and the left eye images 139 and 141 correspond to a perspective of the viewer's left eye, taking into consideration a distance between the viewer's left and right eyes. To create the illusion of the image sequence 136 as a three-dimensional (3D) image in the display device 112, the viewer is allowed to only see the right eye images 138 and 140 with the viewer's right eye and is allowed to only see the left eye images 139 and 141 with the viewer's left eye, as explained in more detail later. There are any number of images in the image sequence 136.

The IHS 100 generates synchronizing information indicating when the right eye images 138 and 140 should be viewed with the viewer's right eye and indicating when the left eye images 139 and 141 should be viewed with the viewer's left eye. The synchronizing information is transmitted as an RF synchronizing information communication signal 144 by the transceiver 128. The transceiver 128 transmits the communication signal 144 at a carrier frequency of approximately 2.4 GHz. When generating the synchronizing information, the IHS 100 takes into consideration factors such as the communication time for the transceiver 128 and the communication signal 144, and a display refresh rate/lag time for the display device 112, as discussed in more detail later.

The glasses 132 and 134 include frames 146 and 148 supporting respective left eye shutters 150 and 152 and respective right eye shutters 154 and 156. The frames 146 and 148 may be worn by a user like a standard pair of eyeglasses or sunglasses. When worn by the user, the frame 146 or 148 holds the shutter 150 or 152 in front of the left eye of the user and holds the shutter 154 or 156 in front of the right eye of the user. The shutters 150, 152, 154 and 156 are liquid crystal filled glass with a polarizing filter. The shutters 150, 152, 154 and 156 each have two operational modes using LCD technology, which are referred to here as the open mode and the closed mode. In the open mode, the shutters 150, 152, 154 and 156 are substantially transparent and are thereby transmissive to radiation (e.g., light), so that the user can see through the shutters 150, 152, 154 and 156. In the closed mode, the shutters 150, 152, 154 and 156 become dark when an electrical voltage is applied to the liquid crystal and thereby substantially block transmission of radiation (e.g., light), so that the user cannot see through the shutters 150, 152, 154 and 156. It is contemplated that other types of shutters may alternatively be used where the shutters are electromechanical or otherwise operate in the open and closed operational modes in different ways.

The shutter glasses 132 and 134 include respective antennas 158 and 160 for receiving the synchronizing information via the communication signals 144 from the transceiver 128. The antennas 158 and 160 are shown in FIG. 2 as extending up from the frames 146 and 148 for the purpose of illustration, however it is contemplated that the antennas 158 and 160 are, at least partially, incorporated into the frames 146 and 148, respectively. Alternatively, the antennas 158 and 160 may extend from the frames 146 and 148. The antennas 158 and 160 communicate the synchronizing information to respective circuits (not visible in FIG. 2) that are provided in the frames 146 and 148 of the glasses 132 and 134, respectively. Each circuit causes the associated shutters 150 and 154 or 152 and 156 to switch between the open and closed operational modes in response to the synchronizing information in received signals 144, as discussed in more detail below.

User push-buttons 162 and 164 are respectively provided in the frames 146 and 148. The buttons 162 and 164 are each electrically coupled to the associated circuit in the respective frame 146 or 148. The buttons 162 and 164 are used to cause the associated glasses 132 or 134 to perform certain operations. For example, when the button 162 or 164 is pressed, the associated circuit in the frame 146 or 148 operates an RF transmitter to transmit communication signal 166 or 168, respectively containing information, such as status information, to the IHS 100 via the transceiver 128. The status information provided by the glasses 132 and 134 to the IHS 100 includes data about a signal strength of the communication signal 144 being received by the glasses 132, 134 from the transceiver 128. Additionally, the status information includes data relating to battery information (e.g., remaining charge) for the circuit in the respective set of glasses 132, 134. Alternatively, the status information 152 may include a test signal so that the IHS 100 can determine a signal strength of the communication signal 166 or 168 being provided by the glasses 132, 134 to the IHS 100.

The button 162 or 164 is also used to communicatively pair the glasses 132, 134 with the IHS 100. Communicative pairing is used to establish a communication relationship between the glasses 132 and 134 and the IHS 100. Each set of glasses 132 and 134 has a unique personal identification number (PIN) stored in the associated circuit provided in each set of glasses 132 and 134. Pairing includes supplying the PIN to the IHS 100, and the PIN allows the IHS 100 to know attributes or features specific to each set of paired glasses 132 or 134. Using this, the IHS 100 can consider features, such as shutter reaction time, for the specific pair of glasses 132 or 134 and use that information when generating the synchronizing information. Additionally, pairing provides a way for IHS 100 to instruct the glasses 132 and 134 when and how to communicate with the IHS 100.

In operation, a user starts a video program, video game or other image sequence that is to be displayed on the display device. The user then puts on a set of glasses 132 and presses the button 162 for a time period long enough that the IHS 100 receives the communication signal 166 from the glasses 132 when the IHS 100 is not broadcasting synchronizing information in a communication signal 144. This communication signal 166 includes the personal identification number (PIN) that is unique to the specific set of glasses 132. In the disclosed embodiment, the PIN includes a portion identifying the manufacturer of the glasses, another portion identifying the model of the glasses, and yet another portion that is a serial number unique to that model by that manufacturer. The IHS 100 then uses the PIN to retrieve information about the specific set of glasses 132 from a look-up table on the HDD 116. In the alternative, the look-up table could be stored on an Internet server (not shown in FIG. 2) that is at a remote physical location but accessible by the IHS 100. The IHS then generates and issues synchronizing communication signals 144, taking information about the paired glasses 132 into consideration. The glasses 132 transmit communication signals 166 to the IHS 100 after pairing, by delaying a unique time interval after receiving a communication signal 144 and then transmitting a communication signal 166 to the IHS 100. The unique time interval is based on the unique PIN of that particular set of glasses 132 or 134, and thus every set of glasses effectively has its own unique time slot for transmitting information back to the IHS 100. As such, communication interference is avoided between multiple sets of glasses 132 and 134 and the IHS 100.

The IHS 100 generates the synchronizing information so that it is correlated to the image sequence 136. The IHS 100 communicates the image sequence 136 to the display device 112 for display, and broadcasts the synchronizing information to all sets of glasses via the communication signals 144. The associated circuitry in each set of glasses 132 and 134 receives the communication signal 144 and processes it to extract the synchronizing information for the specific set of glasses. Based on the extracted synchronizing information the shutters 150, 152, 154 and 156 alternate between the open operational mode (e.g., transmissive to radiation) and closed operational mode (e.g., block radiation) in synchronization with the image sequence 136 displayed on the display device 112. For example, the shutters 150, 152, 154 and 156 alternate between the open operational mode (e.g., transmissive to radiation) and the closed operational mode (e.g., block radiation) in synchronization with the image sequence 136 so that shutters 150 and 152 darken over the users' left eyes and shutters 154 and 156 are transmissive over the users' right eyes when right eye images 138 and 140 are displayed on the display device 112, and then shutters 154 and 156 darken over the users' right eyes and shutters 150 and 152 are transmissive over the users' left eyes when left eye images 139 and 141 are displayed on the display device 112.

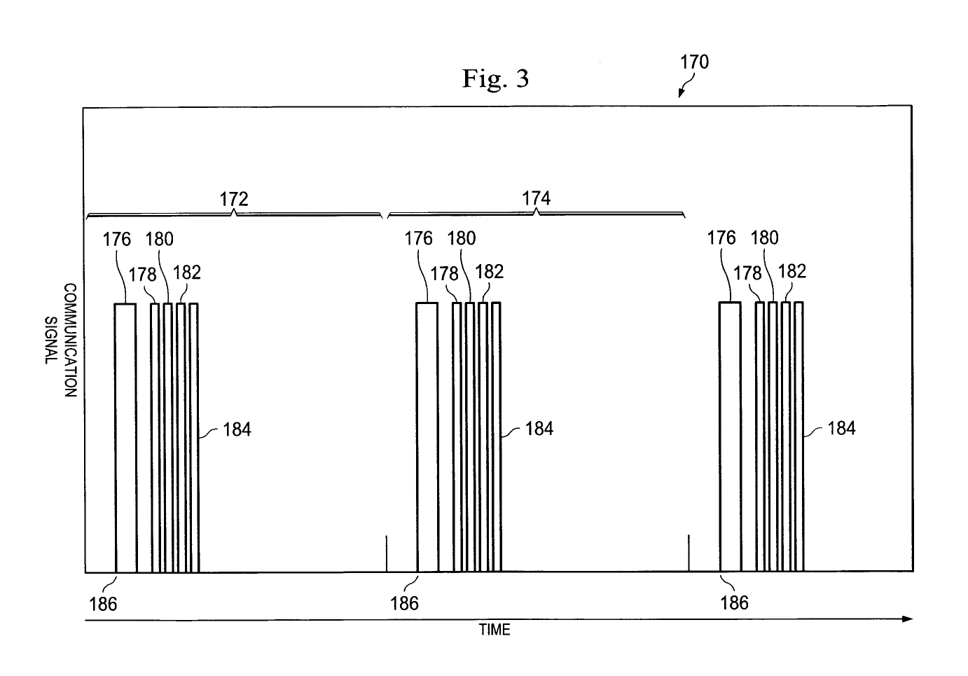

FIG. 3 is a communication signal timing diagram 170 for the communication signals of FIG. 2. The horizontal axis represents time and the vertical axis represents the presence of a communication signal, such as the synchronizing information communication signal 144 and the status information communication signals 166 and 168 of FIG. 2. Along the time axis are a series of similar communication time periods 172 and 174 during which the IHS 100 and the glasses 132 and 134 of FIG. 2 can communicate with one another. The communication periods 172 and 174 have substantially the same duration of time, which is repeated while the synchronizing information is being transmitted. The time periods 172 and 174 each include a synchronizing information communication signal time period 176 that represents a time slot when a synchronizing information communication signal, such as the communication signal 144 of FIG. 2, is transmitted. Each time period 176 is followed by a number of status information communication signal time periods, several of which are shown at 178, 180, 182 and 184. Each of the time periods 178, 180, 182 and 184 represents a respective time slot when one status information communication signal, such as the communication signal 166 or 168, can be transmitted by a respective pair of glasses, such as the glasses 132 or 134. Within each time period 176, transmission of a synchronizing information communication signal begins at a time 186, which represents to the glasses a timing reference point. The different sets of glasses (e.g. 132 and 134) identify their unique time period (e.g., 178, 180, 182 or 184) for return transmissions by delaying from the communication signal beginning time 186 a unique time interval that is based on the unique PIN of that particular pair of glasses, as discussed above.

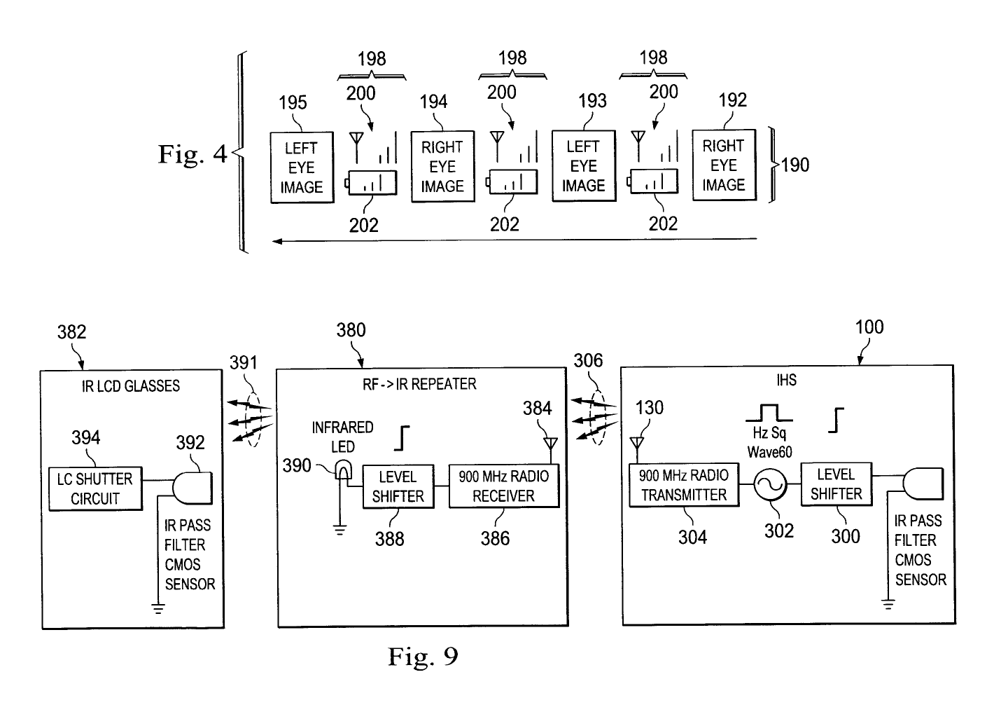

As mentioned above, the glasses 132 and 134 of FIG. 2 transfer status information to the IHS 100 via the communication signals 166 and 168, respectively. FIG. 4 is a block diagram showing an alternative video image sequence 190 including the status information. The image sequence 190 may be displayed on the display device 112 of the IHS 100 in place of the image sequence 136. The image sequence 190 includes a series of right eye images 192 and 194 in alternating sequence with a series of left eye images 193 and 195, which are generally similar to the images 138-141 in the image sequence 136. The status information is interleaved into the image sequence 190 as status information images 198 at a time between the images. The status information images 198 include a signal strength image 200 and a battery level image 202. As an example, the status information images 198 are interleaved into the image sequence 190 at time between the right eye image 192 and the left eye image 193, at a time between the left eye image 193 and the right eye image 194 and again at a time between the right eye image 194 and the left eye image 195.

The image sequence 190 is communicated to the display device 112 and the synchronizing information generated by the IHS 100 for controlling the glasses 132 and 134 is generated and transmitted to the glasses 132 and 134 so that the user of the specific set of glasses 132 or 134 that is providing the status information to the IHS 100 can see the status information on the display device 112, but the user of other sets of glasses cannot see it. For example, where a user is viewing the image sequence 190 on the display device 112 using glasses 134, the status information that is unique to glasses 134, is only displayed on the display device 112 at a time when the user of glasses 134 has at least one open shutter 152 and/or 156, but the a user of glasses 132 has closed shutters 150 and 154. This is controlled by the synchronizing information transmitted via communication signal 144 by the IHS 100 to each set of glasses 132 and 134 that are viewing the image sequence 190 on the display device 112.

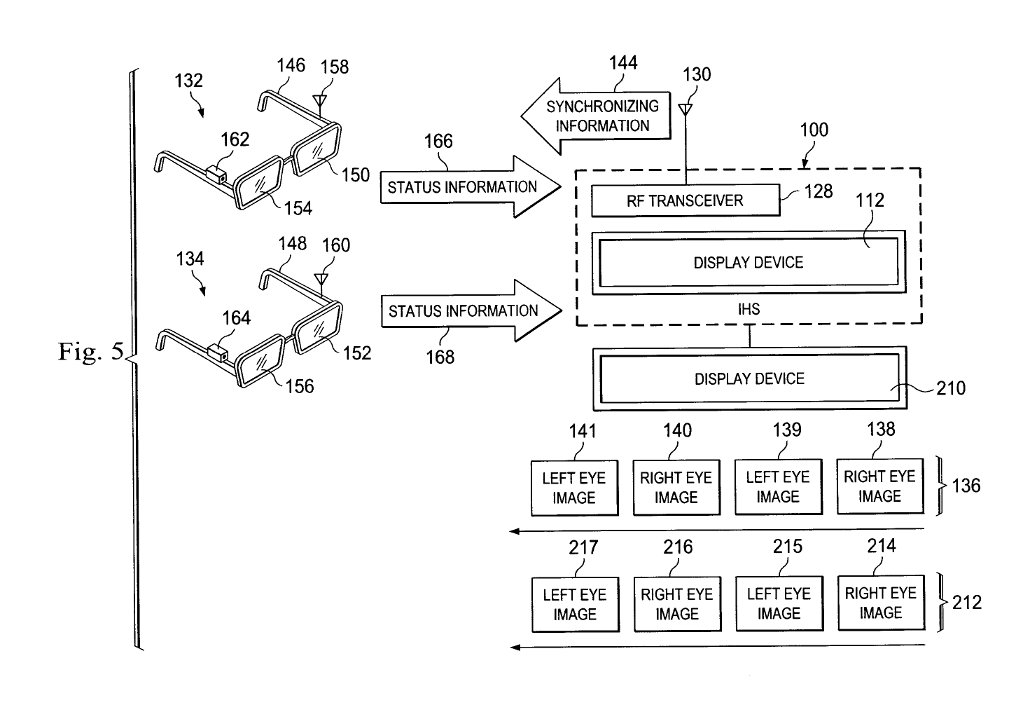

FIG. 5 is a block diagram showing the shutter glasses 132 and 134 and IHS 100 coupled to an additional display device 210. The display device 210 is generally similar to the display device 112. It being understood however, that the display devices may be different formats, such a CRT display device, a projection display device, an LCD display device or other type of display device. The IHS 100 and the glasses 132 and 134 operate substantially the same as described above with reference to FIG. 2. The display device 112 displays the image sequence 136, as described above, and the display device 210 displays the image sequence 212. The image sequence 212 includes a series of right eye images 214 and 216 in alternating sequence with a series of left eye images 215 and 217, which are generally similar to the images 138-141 in the image sequence 136, except that the images 214-217 include different image content than the images 138-141. For example, the image sequence 136 and 212 may display images for different video programs, or one image sequence may display images for a video program and the other image sequence may display images for an IHS gaming application.

The IHS 100 generates the synchronizing information so that it is correlated to both the image sequence 136 and the image sequence 212 and broadcasts the synchronizing information to all sets of glasses (e.g., 132 and 134) via the communication signals 144. The IHS 100 communicates the image sequence 136 and 212 respectively to display devices 112 and 210 for display. Displaying of the image sequences 136 and 212 is correlated so that the right eye images 138 and 214 are displayed at substantially the same time, respectively, left eye images 139 and 215 are displayed at substantially the same time, respectively, right eye images 140 and 216 are displayed at substantially the same time, respectively, and left eye images 141 and 217 are displayed at substantially the same time. Accordingly, the synchronizing information generated by the IHS 100 is generated so that the user of glasses 132 can view both the image sequence 136 and the image sequence 212. Similarly, the user of glasses 134 can view both the image sequence 136 and the image sequence 212. In other words, both images sequences 136 and 212 are synchronized with both sets of glasses 132 and 134. The associated circuitry in each set of glasses 132 and 134 receives the communication signal 144 and processes it to extract the synchronizing information for the specific set of glasses and responds the synchronizing information generally similar to that described above with respect to FIG. 2.

As discussed above, shutter glasses (e.g., 132 and 134) are used for viewing 3D stereoscopic video on 2D display devices (e.g., 112 and 210). An IHS generates synchronizing information to correlate displaying left eye images (e.g., 139, 141, 215 and 217) while right eye shutters (e.g., 154 and 156) over a viewer's right eye are closed. The synchronizing information also correlates displaying right eye images (e.g., 138, 140, 214 and 216) while left eye shutters (e.g., 150 and 152) over a viewer's left eye are closed. This pattern alternates back and forth between the viewer's left and right eyes, using binocular disparity to create an illusion of 3D depth in the video images displayed on a 2D display device. However, the display devices 112 and 210 generally cannot display the images instantaneously, when presented them. In other words, the display devices 112 and 210 have a delay time between being presented the image to display and getting the image completely drawn on the display device 112 and 210. Similarly, the shutters 150, 152, 154 and 156 generally cannot instantaneously transition between the open mode and the closed mode when instructed to do so by the synchronizing information.

Accordingly, the synchronizing information is generated with a timing compensation to reduce ghosting of the images during the transition time period between showing a right eye image and showing a left eye image where only a portion of the right eye image and a portion of the left eye image is displayed. Therefore, the display devices 112 and 210 and the shutters 150, 152, 154 and 156 use timing compensation generated into the synchronizing information to open the right eye shutters 154 and 156 when the right eye images are displayed completely on the display devices 112 and 210 to open the left eye shutters 150 and 152 when the left eye images are displayed completely on the display device 112 and 210. Additionally, because different types of display devices (e.g., LCD, CRT, projection, etc.) have different write speed timing characteristics and also because different shutter glasses have different transition timing characteristics, the synchronizing information includes timing compensation for the different devices by using a least-common denominator approach where the synchronizing information causes the shutters to open after the slowest display device completes transitioning to a new image and then causes the shutters to close before the fastest display device begins transitioning to a new image. The timing characteristics of the glasses is provided to the IHS 100 during a pairing period including a unique PIN, as discussed above with respect to FIG. 2. The timing characteristics of each display device are provided to the IHS 100 via a look-up table after a user enters data relating to a type of the display device.

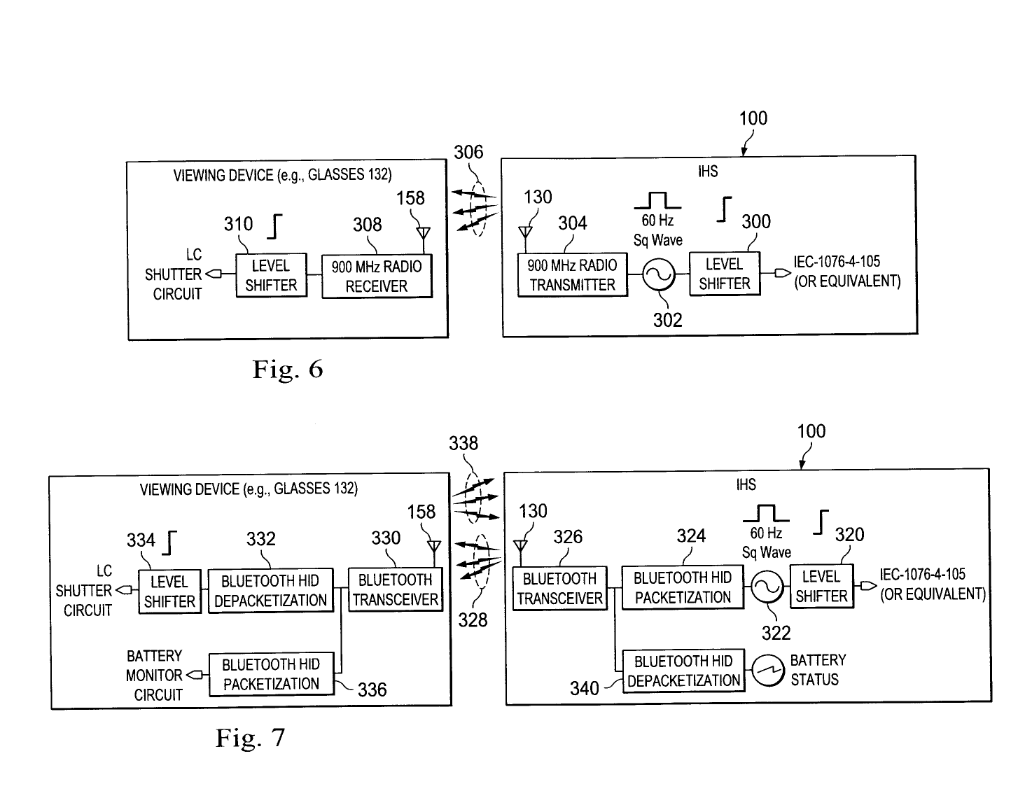

In addition to the communication discussed with respect to FIG. 2 above, FIGS. 6-9 show block diagrams for alternative embodiments of communication for viewing devices (e.g., glasses 132 and/or 134) and the IHS 100. FIG. 6 shows a communication system using the IHS 100 and a viewing device, such as glasses 132. The IHS 100 generates communications signals (e.g., including synchronizing information), which are level shifted (e.g., amplified) using level shifter 300, and merges the level shifted signals with a carrier signal (e.g., a 60 Hz square wave) using a square wave generator 302. An RF transmitter 304 then transmits the communication signals 306, which are radiated at, for example at 900 MHz using antenna 130. The communication signals 306 are received by antenna 158, which communicates the received signals to an RF receiver, which communicates the signals to a level shifter 310. The level shifter 310 amplifies the signals and communicates them to respective shutters (e.g., 150 and 154) for operation.

FIG. 7 shows a communication system using Bluetooth™ communication system using the IHS 100 and a viewing device, such as glasses 132. The IHS 100 generates communications signals (e.g., including synchronizing information), which are level shifted (e.g., amplified) using level shifter 320, and merges the level shifted signals with a carrier signal (e.g., a 60 Hz square wave) using a square wave generator 322. These signals are packetized using a Bluetooth™ HID packetization application 324. A Bluetooth™ transceiver 326 then transmits the communication signals 328, which are radiated as Bluetooth™ communication signals 328 using antenna 130. The communication signals 328 are received by antenna 158, which communicates the received signals to a Bluetooth™ transceiver 330. These signals are depacketized using a Bluetooth™ HID depacketization application 332. The depacketized signals are communicated to a level shifter 334. The level shifter 334 amplifies the signals and communicates them to respective shutters (e.g., 150 and 154) for operation. In return communication, status information (e.g., battery charge status) is communicated to the IHS 100. Battery status signals are communicated to a Bluetooth™ HID packetization application 336. The packetized signals are communicated to the Bluetooth™ transceiver 330 for transmitting via antenna 158 as communication signals 338. Communication signals 338 are received by antenna 130 and communicated to the Bluetooth™ transceiver 326. Transceiver 326 communicates the signal to a Bluetooth™ HID depacketization application 340, which depacketizes the signals and provides them to the IHS 100 for displaying or other use.

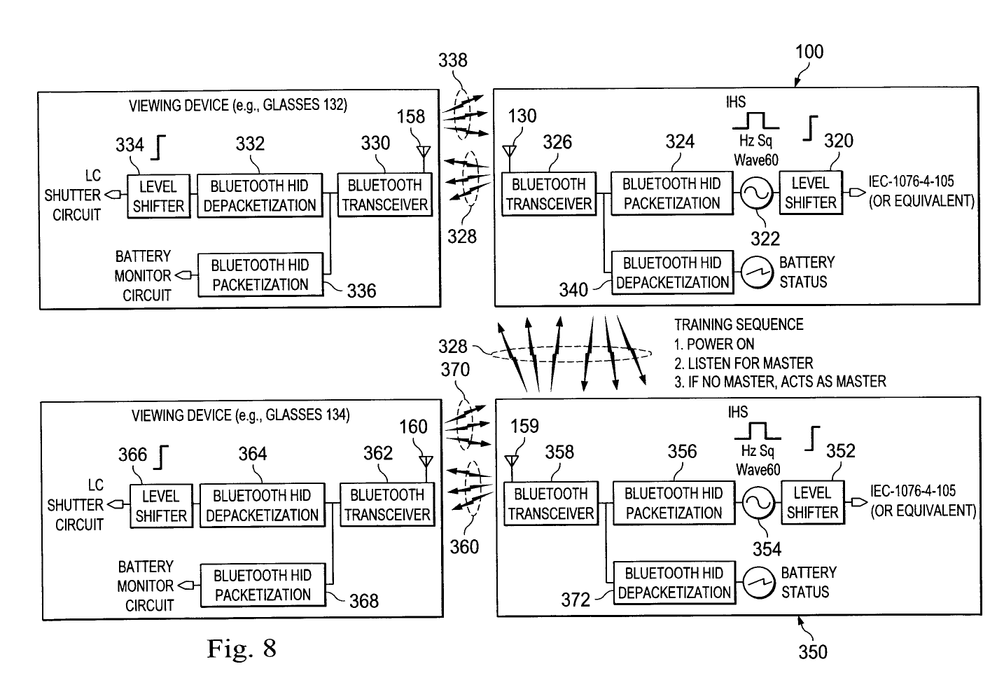

FIG. 8 shows a communication system using generator lock (genlock) technique for multiple IHSs, such as IHS 100 and IHS 350, which is generally similar to the IHS 100, and multiple viewing devices, such as glasses 132 and 134. Genlock is a technique where a video output of one source is used to synchronize a video output of another source. The IHS 100 and the viewing device (e.g., glasses 132 of FIG. 8 are generally similar to that described above for FIG. 7. An additional IHS 350 is communicatively coupled to the IHS 100 for genlocking the IHSs' video outputs.

The IHS 350 generates communications signals (e.g., including synchronizing information), which are level shifted (e.g., amplified) using level shifter 352, and merges the level shifted signals with a carrier signal (e.g., a 60 Hz square wave) using a square wave generator 354. These signals are packetized using a Bluetooth™ HID packetization application 356. A Bluetooth™ transceiver 358 then transmits the communication signals 360, which are radiated using antenna 359. The communication signals 360 are received by antenna 160, which communicates the received signals to a Bluetooth™ transceiver 362. These signals are depacketized using a Bluetooth™ HID depacketization application 364. The depacketized signals are communicated to a level shifter 366. The level shifter 366 amplifies the signals and communicates them to respective shutters (e.g., 152 and 156) for operation. In return communication, status information (e.g., battery charge status) is communicated to the IHS 350. Battery status signals are communicated to a Bluetooth™ HID packetization application 368. The packetized signals are communicated to the Bluetooth™ transceiver 362 for transmitting via antenna 160 as communication signals 370. Communication signals 370 are received by antenna 359 and communicated to the Bluetooth™ transceiver 358. Transceiver 358 communicates the signal to a Bluetooth™ HID depacketization application 372, which depacketizes the signals and provides them to the IHS 350 for displaying or other use.

Additionally, a genlock is performed to communicatively couple IHS 100 and IHS 350. This process is performed by having the IHSs 100 and 350, upon command, execute a training sequence to determine whether IHS 100 or IHS 350 is to operate as a master and which IHS is to operate as a slave in synchronizing the video. Each IHS listens for a period of time for a master transmitting instructions on communication signals 376. In no master is heard, the listening IHS acts as a master to control synchronization of the video signals.

FIG. 9 shows a communication system using the IHS 100 and a viewing device, such as glasses 132 and retransmission of communication signals using IR signals. The IHS 100 of FIG. 9 operates generally similar to the IHS 100 discussed with respect to FIG. 6 and communicates synchronization information via RF signals to an IR repeater device, which in turn, communicates to traditional IR shutter glasses 382. The communication signals 306 are received by antenna 384, which communicates the received signals to an RF receiver 385, which communicates the signals to a level shifter 388. The level shifter 388 amplifies the signals and communicates them to an IR light emitting diode (LED) 390. The IR communication signals 391 emitted by the LED 390 is received by an IR pass filter/sensor 392. The sensor 392 communicates the received communication signals to a shutter circuit 394 and on to respective shutters of the traditional IR shutter glasses for operation.

Accordingly, multicast stereoscopic video synchronization of the present disclosure provides using RF transmitter and receiver pairs inside of, or connected to, a stereoscopic video generator, such as an IHS or set-top box, to simultaneously synchronize the display of stereoscopic video images on one or more display devices with the alternating shutters of multiple active stereoscopic shutter glasses. Multicasting synchronization whereby a stereoscopic video generator signal, encoded in the RF spectrum, can be received and interpreted by multiple pairs of LCD-type shutter glasses, while still preserving device enumeration and targeting capabilities. In one embodiment, this system uses a portion of the unlicensed RF spectrum and an optimal source, such as the VESA standard IEC-1076-4-105 stereoscopic connection type as an input to a stereoscopic video generator circuit. This stereoscopic video generator enables a communication signal, operable to compensate for latencies using configuration information to ensure the time delta between video source and shutter glasses communication signals do not create ghosting or cross talk between the viewer's left and right eyes.

By using RF transceivers, the stereoscopic video generator system and one or more pairs of shutter glasses can operate without the constraints of line-of-sight transmission, which is an issue with purely IR systems, while still enabling targeted point-to-point bidirectional communication between the glasses and the stereoscopic video generator system.

In an embodiment, a repeater of a stereoscopic video source lock signal converts RF to IR and sends the converted signal to one or more pairs of IR shutter glasses. This method uses legacy shutter glasses that do not support RF communication. The stereoscopic video generator synchronizes with a repeater device near a video projection screen. The repeater device level shifts and transmit the communication pulses in the infrared spectrum to legacy shutter glasses as, for example, into a group of viewers located between a video projector and a projection screen. This may be used to bridge legacy shutter glasses to a stereoscopic video generator system.

An advantage of bidirectional IR communication is an ability to genlock many transmitters to many glasses. A stereoscopic video generator system HSS circuit may be designed to enable genlock between itself and other stereoscopic video generator systems, allowing for multiple sources to synchronize with all available shutter glasses. Arbitration is done on a first-come or round robin basis. Once a master is determined, all slaves either align with the signaling of the master, or fail to genlock and revert to their individual timing. This enables many different types of stereoscopic displays to synchronize with many different types of shutter glasses, including IR systems using the repeater device as described above.

By using a genlocked stereoscopic video generator system multiple display devices and multiple types of glasses need not be physically partitioned from one another to reduce interference and crosstalk. Display devices incorporating genlocking stereoscopic video generator system can be closely grouped, and once arbitration is complete and a master is known, all glasses can be synchronized to multiple heterogeneous display systems simultaneously. In an embodiment, glasses communicate status information, such as LCD shutter quality attributes, battery life, signal strength, received pulse rate and a variety of other status information to the stereoscopic video generator system.

Shutter quality information, such as maximum shutter speed and extinguish ratio, allow the stereoscopic video generator system to compensate for different types of shutter glasses by inserting delays back into the audio/video pipeline to accommodate an optimal least common denominator quality rating, from the lowest to highest refresh rate and lowest to highest extinguish ratio. In doing so, heterogeneous types of LCD shutter glasses may be used in close proximity of one another, sharing the same converged host synchronization source.

Although illustrative embodiments have been shown and described, a wide range of modification, change and substitution is contemplated in the foregoing disclosure and in some instances, some features of the embodiments may be employed without a corresponding use of other features. Accordingly, it is appropriate that the appended claims be construed broadly and in a manner consistent with the scope of the embodiments disclosed herein.

What is claimed is:

1. A method comprising:
generating synchronizing information correlated to an image sequence that includes a series of left eye images and a series of right eye images; and
transmitting a radio frequency communication signal that includes the synchronizing information.

2. A method according to claim 1, including:
receiving the communication signal in a device having first and second shutters that each have mutually exclusive first and second operational modes, wherein each of the shutters is transmissive to radiation in the first operational mode thereof and substantially blocks transmission of radiation therethrough in the second operational mode thereof; and
switching each of the first and second shutters between the first and second operational modes thereof as a function of the synchronizing information.

3. A method according to claim 2, wherein the synchronizing information causes each of the shutters to be in the second operational mode for a time period that is longer than each of the shutters is in the first operational mode.

4. A method according to claim 1, including displaying the image sequence.

5. A method according to claim 1, including generating the synchronizing information so that it is correlated to a further image sequence that includes a further series of left eye images and a further series of right eye images, wherein the image sequences are different from each other.

6. A method according to claim 5, including separately displaying each of the image sequences.

7. A method according to claim 1, including:
generating further synchronizing information correlated to the image sequence; and
transmitting a further radio frequency communication signal that includes the further synchronizing information, the synchronizing information in one of the communication signals being different from the synchronizing information in the other of the communication signals.

8. A method according to claim 7, wherein the transmitting of the radio frequency communication signals includes transmitting the radio frequency communication signals at respective frequencies that are different from each other.

9. An apparatus comprising an information handling system that includes:
a processor that executes a synchronizing program to generate synchronizing information correlated to an image sequence that includes a series of left eye images and a series of right eye images; and
a radio frequency transmitter that transmits a wireless communication signal that includes the synchronizing information.

10. An apparatus according to claim 9, including a display device that displays the image sequence.

11. An apparatus according to claim 9, wherein the synchronizing program causes the processor to generate the synchronizing information as a function of display characteristics for a plurality of different display devices.

12. An apparatus according to claim 11, wherein the synchronizing program causes the processor to generate the synchronizing information so that it is correlated to a further image sequence that includes a further series of left eye images and a further series of right eye images and wherein two of the plurality of display devices each display a respective one of the image sequences.

13. An apparatus according to claim 9, wherein the synchronizing program causes the processor to generate the synchronizing information so that it is correlated to a further image sequence that includes a further series of left eye images and a further series of right eye images, the image sequences being different from each other.

14. An apparatus according to claim 9, wherein the information handling system includes a radio frequency receiver receiving a wireless communication signal that includes viewer device status information.

15. An apparatus according to claim 14, wherein the synchronizing program generates the synchronizing information as a function of the status information.

16. An apparatus according to claim 9, wherein the transmitter transmits a further wireless communication signal that includes the synchronizing information, wherein the communication signals are transmitted at respective frequencies that are different.

17. An apparatus according to claim 9, wherein the transmitter transmits a further wireless communication signal that includes further synchronizing information correlated to a further image sequence that includes a further series of left eye images and a further series of right eye images, the synchronizing information in one of the communication signals being different from the synchronizing information in the other of the communication signals, and both communication signals being correlated to both image sequences.

18. An apparatus according to claim 9, wherein the transmitter transmits a further wireless communication signal that includes further synchronizing information correlated to the image sequence, wherein the wireless communication signals are different from one another.

19. An apparatus comprising a viewing device that includes:
a first shutter having mutually exclusive first and second operational modes, wherein in the first operational mode the first shutter is transmissive to radiation and in the second operational mode the first shutter substantially blocks transmission of radiation therethrough;
a second shutter having mutually exclusive first and second operational modes, wherein in the first operational mode the second shutter is transmissive to radiation and in the second operational mode the second shutter substantially blocks transmission of radiation therethrough; and
a circuit that includes a communication receiver that receives radio frequency (RF) communication signals, the circuit causing each of the first and second shutters to switch between the first and second operational modes thereof in response to received communication signals.

20. An apparatus according to claim 19, including a frame supporting the first shutter, the second shutter and the circuit.

21. An apparatus according to claim 19, wherein the first shutter and the second shutter are liquid crystal display (LCD) devices.

22. An apparatus according to claim 19, wherein the circuit also includes a communication transmitter that transmits wireless viewing device communication signals.

23. An apparatus according to claim 22, wherein the communication transmitter transmits the viewing device communication signals at a frequency range within a radio frequency (RF) spectrum.

24. An apparatus according to claim 22, wherein the viewing device communication signals include information relating to one of shutter pulse rate, battery life, image brightness and speed of switching between the first and second operational modes for the first and second shutters.
